(19) United States
(12) Patent Application Publication
(10) Pub. No.: US 2012/0286533 A1
(43) Pub. Date: Nov. 15, 2012

(54) GRIPPER ATTACHMENT FOR ROBOT

(75) Inventors: Michael Mettler, Hazen, ND (US); Dylan Dyke, Plaza, ND (US); Monty Bulzomi, Carrington, ND (US); Kevin Landsverk, Fosston, MN (US); Jeremiah Neubert, Grand Forks, ND (US)

(73) Assignee: UNIVERSITY OF NORTH DAKOTA, Grand Forks, ND (US)

(21) Appl. No.: 13/335,385

(22) Filed: Dec. 22, 2011

Related U.S. Application Data
(60) Provisional application No. 61/485,863, filed on May 13, 2011.

(51) Int. Cl. B25J 15/00

(52) U.S. Cl. 294/213

(57) ABSTRACT

A robot gripper attachment for use with conventional robotic platforms, the gripper having opposed claw members, each claw member in turn having a plurality of elongate projections. An inward facing surface of each projection is chamfered, defining an interior gripping surface. This gripping surface may be further provided with a friction material for increased grip. One or more cameras and sensors may be utilized to aid operation by providing the operator with information about depth, distance, and positioning.

### CROSS-REFERENCE TO RELATED APPLICATIONS

This application claims priority from provisional application Ser. No. 61/485,863, filed Dec. 22, 2010, which is incorporated by reference.

### BACKGROUND OF THE INVENTION

1. Field of the Invention

The present disclosure is in the field of robotics. More particularly, the present disclosure is concerned with end effectors for robots. Specifically, the present disclosure addresses gripping devices for robots, such as robots used for law enforcement, military and paramilitary purposes. Also known as ‘bomb-squad robots,’ these apparatuses are often equipped with interchangeable attachments for achieving desired objectives such as performing reconnaissance, manipulating target objects, disabling suspicious devices, or gaining access to premises. Such attachments are remotely actuated and controlled utilizing techniques that are well known in the art.

2. Background Art

Conventional law enforcement robots equipped with opposed claw members have difficulty breaching doors that require operating a doorknob. The main difficulty is in achieving and maintaining a sufficient grip on a doorknob to turn it and push/pull the door open. The inability to breach these types of doors can severely limit the usefulness of such robots.

In one case study, an urban bomb squad needed more than one full hour for a conventionally equipped robot to open a door with a knob in an emergency situation. This amount of time was deemed unacceptable by authorities for the reason that people can make non-intelligent decisions in the matter of a few minutes, jeopardizing lives as well as property or valuable evidence of criminal activity.

There is a need for an improved robot attachment that is capable of gripping a doorknob sufficiently to both turn the knob and push/pull a door open.

There is further a need for a robot attachment having an operation that is both simple and efficient, and that optimizes cost, adaptability, strength, robustness and sustainability while minimizing unintended collateral damage to property.

There is also a need for an improved gripper that is easily retrofitted onto existing robots.

There is yet another need for a robot attachment that seamlessly integrates and does not interfere with the robot's existing functionality.

### BRIEF SUMMARY OF THE INVENTION

Disclosed herein is a robot gripper attachment for use with conventional robotic platforms, the gripper having opposed claw members pivotable about a central axis, each claw member in turn having a plurality of elongate projections. An inward facing surface of each projection is chamfered, defining a semi-continuous gripping surface. This gripping surface may be further provided with a friction, textured or non-slip material for increased grip. As will be appreciated, cameras and sensors may be utilized to aid in the opening of a door. The sensor will allow the robot operator to know when the end of the robot arm is a certain distance away from the door, indicating when the operator should actuate the grippers to close. The camera will be positioned between the claws so the operator will have a better understanding of where the gripper is located in relation to objects it is trying to grasp. These two additional modifications will allow the operator to have better depth perception of where the doorknob is and to simplify alignment of the grippers with the doorknob.

### BRIEF DESCRIPTION OF THE DRAWINGS

FIG. 1 is a perspective view of an embodiment of the present disclosure.

FIG. 2 is a perspective view of an embodiment of the present disclosure.

FIG. 2A is a perspective view of a one of the claims showing the high friction coating.

FIG. 3 is a top plan view of an embodiment of the present disclosure.

FIG. 4 is a partial, end plan view of an embodiment of the present disclosure.

FIG. 5 is a partial, end plan view of an embodiment of the present disclosure.

FIG. 6 is a partial, end plan view and force diagram of an embodiment of the present disclosure.

FIGS. 7 and 8 are force diagrams depicting a prior art doorknob.

### DETAILED DESCRIPTION OF THE INVENTION

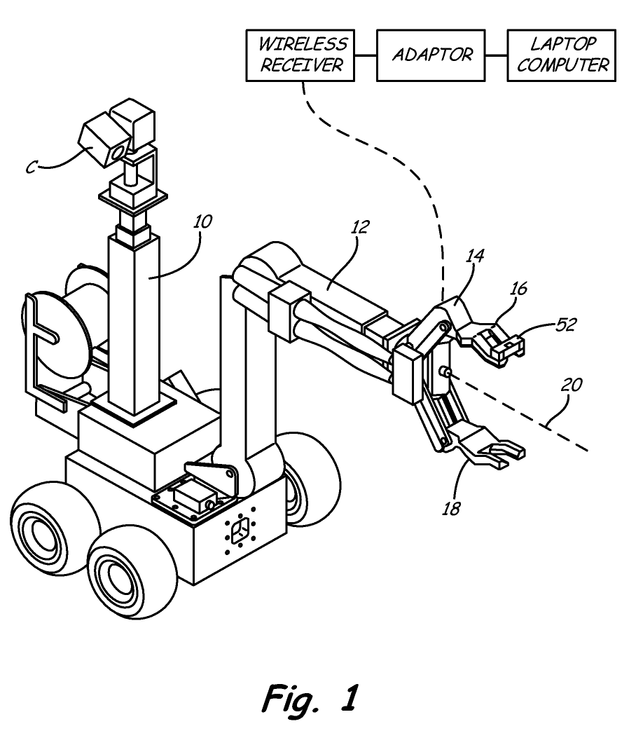

Depicted in FIG. 1 is a conventional robot 10. As illustrated, robot 10 happens to be a Remotec® (REMOTEC, INC., Oak Ridge, Tenn.) ANDROS F6A (Northrup Grumman Information Services), but it will be appreciated that any comparable or similar robotic device, such as those used for law enforcement, public safety, military, or paramilitary applications, may be employed. Robot 10 comprises an articulated arm 12. Mounted at the distal end of arm 12 is an end effector, or gripper, 14. Via means that are conventional and well known in the art, gripper 14 is in electronic, hydraulic and/or physical communication with, and is operably connected to, arm 12. Video camera C mounted on robot 10 views gripper 14 and provides images for use by operator.

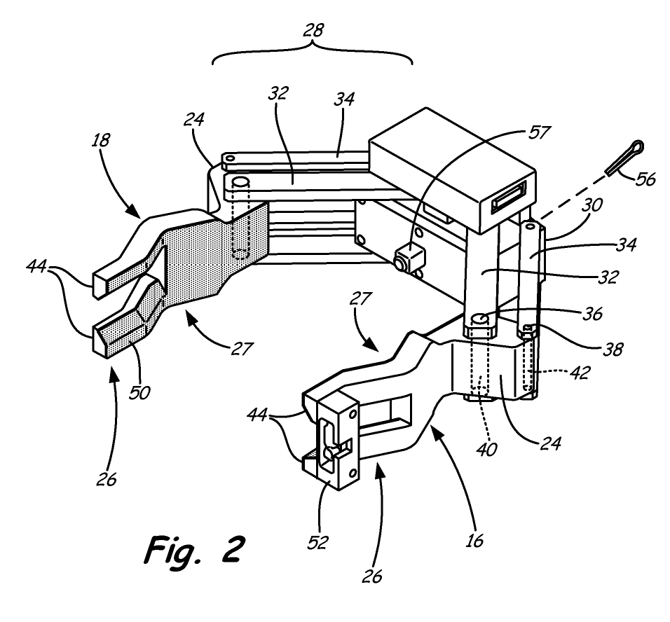

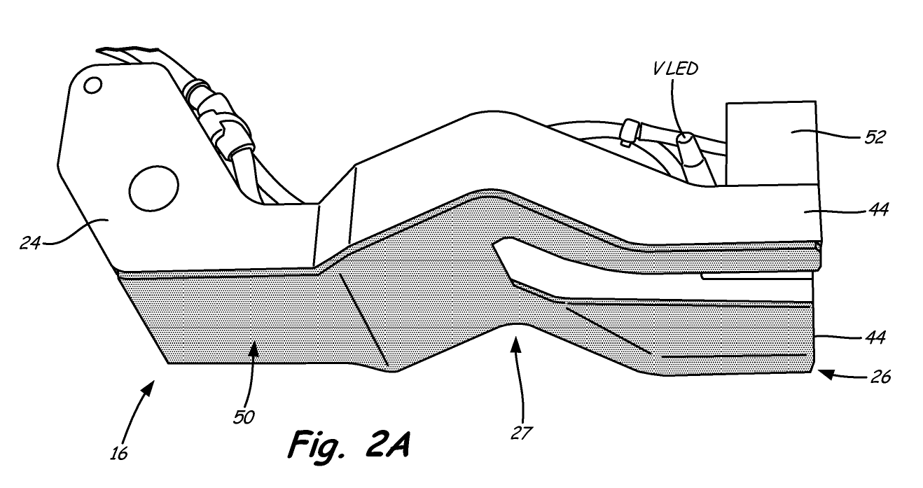

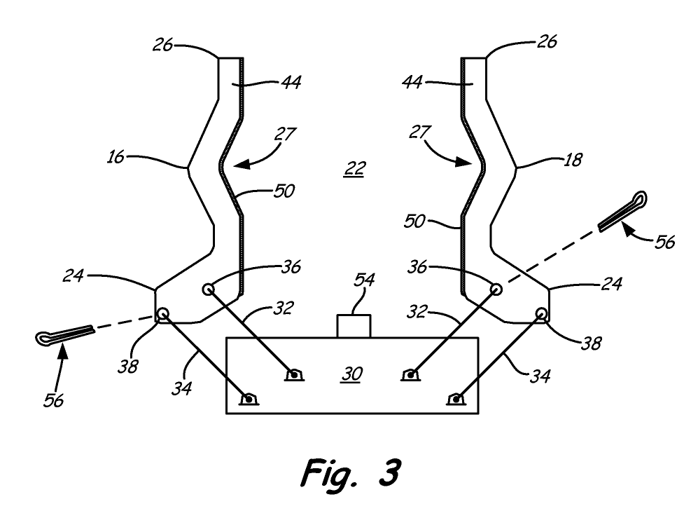

Turning to FIG. 2, gripper 14 further comprises a first claw member 16 and a second claw member 18 opposed and symmetric to first claw member 16. Claw members 16, 18 are preferably identical or substantially similar in size and composition, and are in a mirror-image orientation about the axis 20 defined by the distal end of arm 12. Gripper 14 substantially shares axis 20 with arm 12. Claw members 16, 18 are preferably angular such that when mated, a space 22 is defined between them, as shown in FIG. 3. It will be appreciated that space 22 is particularly well adapted to receive a doorknob or other bulbous or protruding object.

Each claw member 16, 18 has a proximal end 24 and a distal end 26, and a concave portion 27 located between proximal and distal ends 24 and 26. Proximal ends 24 of claw members 16, 18 are pivotably or hingedly attached to a conventional actuation means 28 such that claw members 16, 18 are movable inward and outward with respect to central axis 20 while remaining parallel to one another, and gripper 14 is rotatable around central axis 20. Actuation means 28 is further pivotably or hingedly attached to a conventional control means 30. Control means 30 is, in turn, operably connected to the distal end of arm 12 via means that are well known.

Still referring to FIG. 2, in an exemplary configuration, conventional actuation means 28 comprises parallelogram linkage for each claw members 16, 18. Each linkage includes a pair of inner actuator bars or links 32 and a pair of outer actuator bars or links 34 disposed at opposite ends of proximal end 24. At their distal ends, actuator bars 32, 34 are pivotably or hingedly connected to proximal end 24 of claw members 16, 18 respectively. This connection may be via a pivot point (pin) 36, 38 about (disposed within a corresponding transverse channel 40, 42 through) proximal end 24 of claw mounted 16, 18. Each pivot point (pin) 36 engages the distal ends of corresponding inner actuator bars 32 and each pivot point (pin) 38 engages the distal ends of outer actuator bars 34, respectively.

At their proximal ends, actuator bars 32, 34 are pivotably or hingedly connected to control means 30. Control means 30 drives or rotates actuator bars 32, 34 to cause movement of claw members 16, 18, and may include an actuator such as an independent motor for each pair of actuator bars. In other words, control means 30 has an independent motor for outer actuator bars 32 of claw member 16, for inner actuator bars 34 of claw member 16, for inner actuator bars 34 of claw member 18, and for outer actuator bars 32 of claw member 18.

It will be appreciated that as inner actuator bars 32 are actuated by control means 30, either or both of claw members 16, 18 will move in a single plane relative to one another and relative to control means 30. As either or both outer actuator bars 34 are actuated by control means 30, they will act on proximal end 24 of claw members 16, 18 resulting in the corresponding claw member 16, 18 being pivoted relative to inner actuator bars 32. In this manner, the distance between claw members 16, 18 may be increased or decreased, and the relative positioning of claw members 16, 18 vis-à-vis one another may also be controlled. The foregoing method for manipulating a robotic gripper is well known in the art, and any comparable means for manipulating a robot may be employed with respect to the present disclosure.

Distal end 26 of each claw member 16, 18 is further characterized by elongate projections or fingers 44. In an exemplary embodiment shown in FIG. 2, there are a total of four projections 44, two parallel projections on claw member 16 and two on claw member 18. Projections 44 extend away from proximal ends 24 of claw members 16, 18. Projections 44 are fixed relative to their respective claw member 16, 18. In the embodiment shown in FIG. 2, concave portions 27 of claw members 16, 18 are generally V-shaped, and projections or fingers 44 extend from the midpoint or apex of the V to distal ends 26.

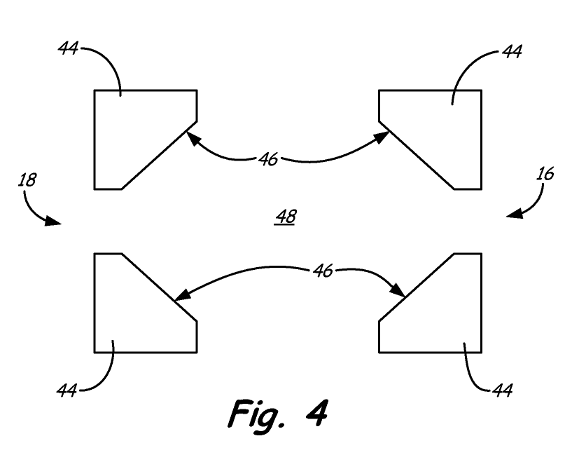

Projections 44 are preferably geometric—pentagonal, for example—in cross-section. An inward facing surface 46 of each projection 44 is chamfered, and projections 44 are preferably configured such that the projections 44 on each claw member are symmetric vis-à-vis one another, and that each claw member 16, 18 is symmetric vis-à-vis one another. In other words, as illustrated in FIG. 4, the inward facing surface 46 of each projection 44 is chamfered so as to define an interior space 48. For purposes of this disclosure, “inward” can be said to be relative to axis 20 (FIG. 1). Still referring to FIG. 4, chamfered edges 46, with or without contiguous and adjacent surfaces of projections 44, can be said to define a semi-continuous gripping surface substantially around space 48.

To increase friction for gripping, inward facing surfaces 46 of projections 44 are preferably provided with a rough, textured, or non-slip material such as a high grip or high friction rubber coating 50 made of natural gum rubber or the like. Coating 50 extends from distal ends 26 through concave portions 27 toward proximal ends 24 as shown in FIGS. 2 and 2A.

In various alternative embodiments, one or both of claw members 16, 18 may be fitted with sensor means 52, which includes an infrared (IR) source (e.g. and IR LED), an infrared (IR) sensor (e.g. a IR photodiod), a visible light LED, and a circuit. Sensor means 52 may be used to measure environmental information such as relative distance between gripper 14 and another surface such as a door. Sensor means 52 is preferably a distance-measuring device equipped with a circuit to power IR source, the IR sensor and light the visible light LED (not shown). The visible light LED is used to indicate when the end of gripper is a proper distance from an object such as a door in order to grasp a target object such as a knob or handle. The IR source directs IR radiation toward axis 20 and the opposite claw member, and the IR detector receives any of that IR radiation that is reflected back by an object in the space between the claw members. When an object is detected, the visible light LED which faces in the proximal direction is turned on. The circuit contains components to filter 9V power into 5V for use by sensor means 52. The circuit also contains an op-amp used to filter the IR sensor output voltage into a current used to light the visible light LED when the object is at a selected distance from sensor means 52. Sensor means 52 is mounted near the distal end 26 of one or both of claw members 16, 18. In one embodiment, sensor means 52 comprises a housing that both serves as a point of attachment to gripper 14 and protects sensor means 52.

In operation, sensor means 52 lights the visible light LED when gripper 14 is at a proper distance from an object such as a door. Using the line tools generated by software, the center of the target object can be aligned with the virtual circle on a viewing screen (not shown). At this point, the operator can close claw members 16, 18 and continue to open the door. In an exemplary embodiment, sensor means 52 is set to turn on the visible light LED when the object is at a distance of approximately 1.50 inches. This distance should be sufficient if sensor means 52 is placed at the end of the claw member 16, 18 and the claw members are approximately 5 inches apart when approaching the doorknob. Output from sensor means 52 is read by an attached circuit (not shown). The circuit is also used to filter the 9V power source into a useable 5V source. The circuit also contains all of the electrical components necessary to read the sensor output voltage and light the visible LED when gripper 14 is at the proper distance. Camera C is positioned to view the visible LED (which faces the proximal direction) so that an operator can see when the visible LED is turned on and can then issue a command to close the gripper 14 on the object.

Gripper 14 may also be fitted with one or more illumination sources and/or closed circuit video equipment to assist the operator with remote operation. A conventional wireless camera system 54 is mounted on control means 30 looking down the central axis 20 of gripper 14. The position of camera 54 gives a point of view perspective to better align the gripper 14 with the center of a target object such as a doorknob. Camera 54 is used to directly view space 22 as well as the environment both immediately around as well as inside of gripper 14 as it grasps a target object such as a doorknob. It will be appreciated that not every conventional camera system allows for this type of close-up view. Wireless camera 54 is powered by the same 9V battery used to power the sensor means 52 and its associated LED. Camera 54 may be attached to gripper 14 by any conventional means; preferably, a hook and loop fastener such as Velcro® is used to attach camera 54 to gripper 14 for easy removal.

In order to view the video from the wireless camera 54, a wireless receiver R (shown in FIG. 1) is used. The receiver is preferably connected to an RCA-to-USB adapter A (shown in FIG. 1). This allows the video output to be received on a laptop computer L (shown in FIG. 1).

Wireless camera system 54 is used to align gripper 14 with a target object such as a doorknob. Conventional cameras (such as camera C in FIG. 1) typically provide only an over-the-shoulder look at an end effector. This makes it very difficult to properly align the end of the gripping apparatus to the doorknob. If a gripper is not positioned relatively correctly with the knob, a robot can have difficulties gripping and turning the knob. Camera system 54 is positioned on the robot to give a close-up view of the claws gripping the knob. This view will allow for proper alignment of the claws. By adding the camera 54 function with the distance output from the sensor means 52, the operator should have very little trouble aligning the claws properly.

The receiver R and RCA adaptor A are used to input the video from the camera 54 to a computer L. The computer L is used to display and record the video. The computer L is also used to program a targeting system for the robot. The targeting system consists of vertical lines for the claws to line up with and a circle to align the doorknob to. The combination of the two alignment markers allows for precise alignment with the doorknob and the correct positioning of the sensor means 52.

Gripper 14 is adapted to receive an average doorknob, so that the robot 10 can then spin its end effector to turn the doorknob to get the door open, allowing robot 10 to negotiate a doorway. In a preferred embodiment, gripper 14 requires no electric inputs from, and makes no major modifications to, the existing robot.

Referring back to FIG. 2, interchangeability of gripper 14 may be aided by utilizing fasteners 56 such as hairpins or cotter pins in conjunction with pivot pins 36, 38, to speed up the process of switching end effector attachments. In operation, an in-place end effector may be detached from robot 10 by opening the fasteners 56 and removing the end effector from bars 32, 34 of actuation means 28. Gripper 14 may then be secured to bars 32, 34, respectively, of actuation means 28 by inserting pivot pins 36, 38 and securing them to actuation means 28 with the fasteners 56.

In one embodiment, claw members 16, 18 of gripper 14 are made of solid 6061-T6 aluminum machined using a CNC mill. Gripper 14 could be machined from an aluminum bar using a CNC machine. Alternatively, die-casting could be used.

Claw members 16, 18 of gripper 14 serve the purpose of gripping an object such as a doorknob and allowing the robot 10 to, for example, turn the knob and push or pull the door open. Gripper 14 also functions to pick up, carry or drag other objects as needed.

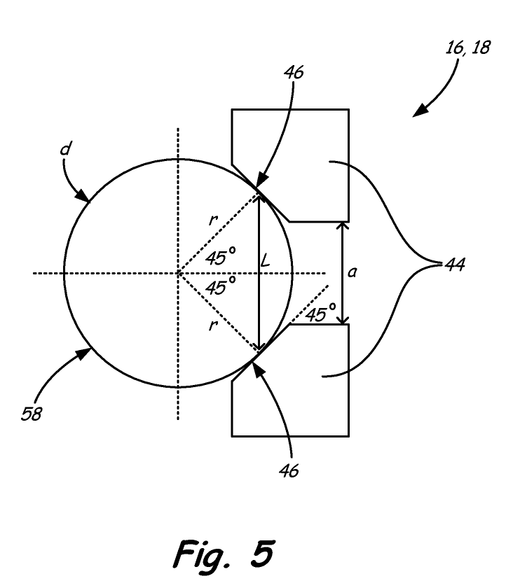

FIG. 5 shows an end view of a claw member 16, 18 of gripper 14 grasping a round doorknob 58. The optimal separation (a) between projections 44 about a single claw member 16, 18 is determined mathematically by comparing doorknob diameter (d) with the length of chamfered edges 46. Assuming an ideal doorknob 58 having a diameter (d) of 2 inches and the length of chamfered edges 46 to be 0.375 inches, and a length (L) between the centers of chamfered edges 46, it is determined that the optimal separation (a) between projections 46 should be 1.145 inches:

### Description of Variables:

a=Distance Between Forks on Gripper
d=Diameter of Door Knob

### L=Length Between Centers of Chamfered Edges

r=Radius of Door Knob

$$r = \frac{d}{2} \\ \begin{matrix}L = 2 r sin ( 45 ° ) \\ = 2 ( \frac{d}{2} ) sin ( 45 ° ) \\ = d sin ( 45 ° ) \\ = 2 sin ( 45 ° ) \\ = 1.41 in\end{matrix} \\ a = 1.41 - ( 2 ) ( \frac{0.375}{2} ) sin ( 45 ° ) = 1.145 in \qquad Equations$$

Because of the chamfered edges 46, gripper 14 will be able to accommodate doorknob diameters both larger and smaller than the ideal diameter it was designed for.

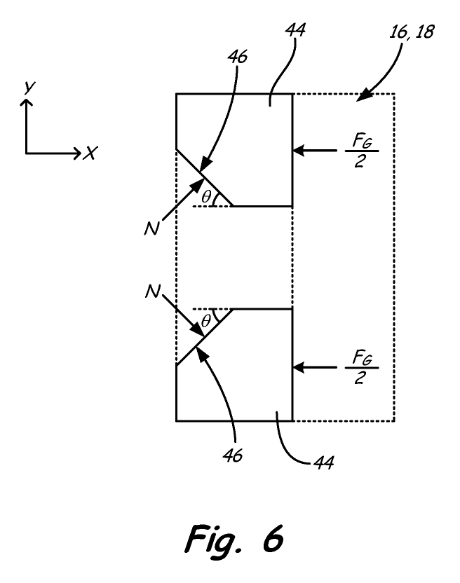

Turning to FIG. 6, in order to calculate the normal force that could be achieved by applying a specific gripping force (F_{G}) to gripper 14, the maximum rated gripping force of 50 pounds for the ANDROS F6A robot 10 must be considered, along with the angle (Θ) of chamfered edges 46. In determining the friction force, an experimentally-determined value of 0.33 is used for the static coefficient of friction (μₛ) for natural gum rubber 50. As illustrated below, the friction force (Ff^{A}) that can be achieved involved a factor of four because there will be four chamfered gripping surfaces 46, two on each claw member 16, 18.

Description of Variables:

F_{f}_{_{A}}=Friction Force Achieved

F_{G}=Robot Gripping Force

N=Normal Force Achieved

θ=Chamfer Angle

μₛ=Coefficient of Static Friction

Normal Force Achieved:

$$\sum {F}_{X} = 2 N sin θ - 2 ( \frac{{F}_{G}}{2} ) = 0$$

$$N = \frac{{F}_{G}}{2 sin θ} = \frac{50}{2 sin ( 45 ° )} = 35.36 lbs$$

Friction Force Achieved:

F_{f}_{_{A}}=4 μₛ N=(4)(0.33)(35.36)=46.68 lbs

It will be appreciated that the friction force achieved by gripper 14 is hereby optimized.

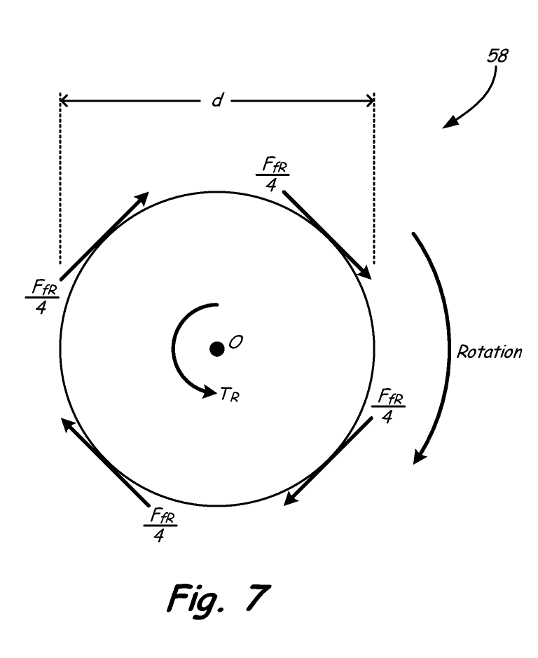

Now referring to FIG. 7, it is possible to calculate the friction force that is required to turn an average doorknob 58. It shows four friction forces (Ff_{R}) acting on the outside of doorknob 58, corresponding to the four gripping surfaces 46 in an exemplary embodiment of gripper 14. The resistive torque (T_{R}) of doorknob 58 was an observed average value of 11.25 in·lbs. The minimum required gripping force (F_{MIN}) was calculated to show the minimum gripping capability any robot 10 would need to have to turn a doorknob 58 with gripper 14, as shown below:

Description of Variables:

| | |
|---|---|
| d = Diameter of Door Knob | SF = Safety Factor |
| F_{f}_{_{A}} = Friction Force Achieved | T_{R} = Resistive Torque of Door Knob |
| F_{f}_{_{R}} = Friction Force Required | θ = Chamfer Angle |
| F_{MIN} = Minimum Required | μₛ = Coefficient of Static Friction |
| Gripping Force | |

Friction Force Required to Turn Knob:

$$\sum {M}_{O} = {T}_{R} - ( 4 ) ( \frac{{F}_{{f}_{R}}}{4} ) ( \frac{d}{2} ) = 0$$

$${F}_{{f}_{R}} = \frac{2 {T}_{R}}{d} = \frac{( 2 ) ( 11.25 )}{2} = 11.25 lbs$$

Safety Factor to Turn Knob:

$$SF = \frac{{F}_{{f}_{A}}}{{F}_{{f}_{R}}} = \frac{46.68}{11.25} = 4.1$$

Minimum Gripping Force to Turn Knob:

$$\frac{4 {μ}_{s} {F}_{MI N}}{2 sin θ} = \frac{2 {T}_{R}}{d}$$

$${F}_{MI N} = \frac{{T}_{R} sin θ}{{μ}_{s} d} = \frac{( 11.25 ) sin ( 45 ° )}{( 0.33 ) ( 2 )} = 12.05 lbs$$

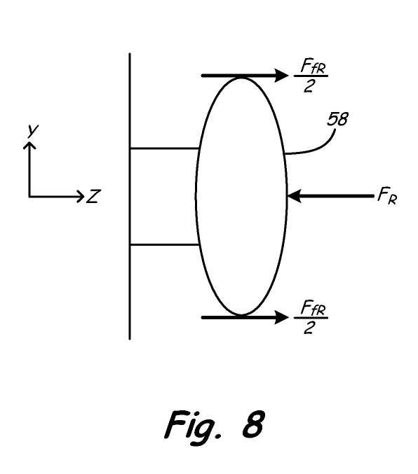

Now describing FIG. 8, it is possible to calculate the friction force that is required to pull an average door open. The resistive pulling force (F_{R}) of the door used was an observed average value of 10.0 pounds, as shown below:

Description of Variables:

| | |
|---|---|
| F_{fA} = Friction Force Achieved | SF = Safety Factor |
| F_{fR} = Friction Force Required | θ = Chamfer Angle |
| F_{MIN} = Minimum Required Gripping | μₛ = Coefficient of Static Friction |
| Force | |
| F_{R} = Resistive Pulling Force of Door | |

Friction Force Required to Pull Door Open:

$$\sum {F}_{Z} = ( 2 ) ( \frac{{F}_{{f}_{R}}}{2} ) - {F}_{R} = 0$$

$${F}_{{f}_{R}} = {F}_{R} = 10.00 lbs$$

Safety Factor to Pull Door Open:

$$SF = \frac{{F}_{{f}_{A}}}{{F}_{{f}_{R}}} = \frac{46.68}{10.00} = 4.7$$

Minimum Gripping Force to Pull Door Open:

$$\frac{4 {μ}_{s} {F}_{M IN}}{2 sin θ} = {F}_{R}$$

$${F}_{M IN} = \frac{{F}_{R} sin θ}{2 {μ}_{s}} = \frac{( 10 ) sin ( 45 ° )}{( 2 ) ( 0.33 )} = 10.71 lbs$$

Whereas, the present invention has been described in relation to the drawings attached hereto, it should be understood that other and further modifications, apart from those shown or suggested herein, might be made within the spirit and scope of this invention.

We claim:

1. A gripper attachment for a robot, comprising:
a plurality of claw members, each claw member further comprising a plurality of fixed, elongate projections that extend parallel to one another to a distal end of the claw member, each of the projections further comprising an inward-facing chamfered edge;
wherein said chamfered edges define a plurality of surfaces for gripping objects.

2. The gripper attachment of claim 1 further comprising an infrared sensor attached to at least one of said claw members.

3. The gripper attachment of claim 1 further comprising a video camera that is positioned to view a region between the claw members.

4. The gripper attachment of claim 1 wherein the claw members are symmetric.

5. The gripper attachment of claim 1 wherein each claw members include a concave portion between its distal end and a proximal end, and wherein the concave portions of opposing claw members define a space therebetween for receiving and gripping an object.

6. The gripper attachment of claim 5 wherein said object is bulbous.

7. The gripper attachment of claim 6 wherein said object is a doorknob.

8. The gripper attachment of claim 1 wherein at least one of said chamfered edges is provided with a friction surface.

9. The gripper attachment of claim 8 wherein said friction surface is rubber.

10. The gripper attachment of claim 1 wherein each claw member comprises two projections.

11. The gripper attachment of claim 1 wherein the projections are pentagonal in cross-section.

12. The gripper attachment of claim 1 further comprising attachment means for removably securing the claw members to a robotic arm.

13. The gripper attachment of claim 12 wherein said attachment means are selected from the group consisting of hairpins and cotter pins.

14. The gripper attachment of claim 1 wherein each said chamfered edge is approximately 0.375 inches in length, wherein said chamfer is at an angle of approximately 45 degrees, and wherein said projections are separated about their respective said claw member by approximately 1.145 inches.

15. A gripper attachment for a robot, comprising:
two symmetric, opposed claw members, each having a proximal end and a distal end, a concave portion on a inward facing side, and a pair of parallel fingers extending from the concave portion to the distal end wherein the fingers include an inward-facing chamfered edge with a friction surface;
a sensor for detecting when an object is near the claw members; and
a video camera for viewing a space between the claws.

16. A gripper attachment for a robot, comprising:
a plurality of claw members pivotable about a central axis;
wherein each claw member includes a plurality of inward-facing chamfered edges forming a semi-continuous gripping surface.

17. The gripper attachment of claim 16, wherein the semi-continuous gripping surface further comprises non-chamfered edges of said claw members.
